(19) United States
(12) Patent Application Publication
(10) Pub. No.: US 2010/0102478 A1
(43) Pub. Date: Apr. 29, 2010

(54) Method of fabricating bath-models for nickel shells

(76) Inventors: Flavio Maschera, Gorgonzola (IT); Pedro Barrote, Porto (PT)

Correspondence Address: WILLIAM B RITCHIE;LAW OFICE OF WILLIAM B. RITCHIE, 413 NOBLE FAIRE DRIVE, SUN CITY CENTER, FL, 33573, US

(21) Appl. No.: 12/589,312

(22) Filed: Oct. 21, 2009

Related U.S. Application Data
(60) Provisional application No. 61/197,086, filed on Oct. 23, 2008.

(51) Int. Cl. B29C 33/38

(52) U.S. Cl. 264/227

(57) ABSTRACT

A method of model fabrication wherein a cast metal mold is coated with a low melting point metal alloy that is then over-coated with a nickel alloy by electro-deposition to provide a nickel shell mold that may be released from the base-model by melting the low melting point metal alloy. The method is particularly useful for producing thermoplastic elastomeric skins with a predetermined three-dimensional pattern molded thereon.

This application claims benefit under Title 35 U.S.C. §119(e) of U.S. Provisional Application Ser. No. 61/197,086 filed Oct. 23, 2008.

### FIELD OF THE INVENTION

The invention relates to a method to produce a bath-model for a shell, and in particular, a nickel shell for production of thermoplastic elastomeric skins used for slush molding, vacuum thermoforming processes and other forming techniques.

### BACKGROUND OF THE INVENTION

The prior art method for the production of electro-deposited nickel shells used for slush molding or vacuum thermoforming processes are characterized by manufacturing shells by electro-depositing nickel over a textured resin bath-model appropriately plated by conductive material. Representative of the prior art process is the technique utilized by the German manufacturer GALVANOFORM as further described in their web page www.galvanoform.de/sites/english/techno_uk.html, incorporated herein in its entirety by reference.

Bath-models are replicas from negative silicone casts of a resin mother-model. A mother-model is the reference for its corresponding bath-model. The mother-model itself is obtained from a negative silicone master cast obtained from a master-model. The master-model is produced by machining a 3-dimensional core surface into a resin block and then, manually wrapping the resin block with natural or artificial skins. In this manner, the wrapped (or leathered) resin block is representative of the final appearance of the desired part. In fact, the desired parts are produced by wrapping slush-molded skins or vacuum thermoforming skins, obtained from the above-mentioned nickel deposited shells, onto components which present external surfaces similar to the resin block.

There are several limitations found in the prior art. Primarily, the above described prior art process includes multiple steps to obtain an electro-deposited nickel shell from a master-model. In other words, a master-model must be used to make the mother-model that in turn is used to make the bath-model. The process is long and an expensive one. Secondarily, the release of each nickel shell typically results in the destruction of the bath-model as a consequence of scrapping the resin material during the release procedure. Finally, nickel shells produced by prior art methods do not blend well in appearance with parts made using other techniques. This is especially true of injection-molded parts.

In U.S. Pat. No. 3,729,388 issued to De Angelo et al. on Apr. 24, 1973, a method of producing a nickel shell is disclosed. With this method, an electrolytic nickel-plating treatment is utilized to build up a desired thickness of material on the base substrate. No meltable bath-model is disclosed or suggested.

Another method of producing a nickel shell mold is disclosed in U.S. Pat. No. 5,169,549 issued to Weber on Dec. 8, 1992. Weber discloses a method of manufacturing a nickel shell by vapor deposition on a combination steel parting line and manifold with a plurality of heating and cooling lines operatively connected to the manifold for flowing heated or cooling fluid there through. Again, Weber does not disclose or suggest the use of a meltable model for the vapor deposition.

### SUMMARY OF THE INVENTION

It is an aspect of the invention to provide a method to produce a bath-model for nickel shells from a machined and negative textured master-cavity steel model defined as a mother-model.

It is another aspect of the invention to provide a method that reduces the number of steps required for the modeling process for the production of electro-deposited nickel shells.

It is still another aspect of the invention to provide a method that substantially reduces the time-to-market required to produce the electro-deposited nickel shells as well as reducing the cost for the new elastomeric skins produced therefrom.

Another aspect of the invention is to provide a method that allows for appearance harmonization among the different texturing processes, thus significantly extending the possibilities for interior designers in different applications.

It is still another aspect of the invention to provide a method for producing textured grains onto complex shapes from steel mother-model in such a way that seams or stitches are not visible on the surface.

Still another aspect of the invention is to provide a method in which nickel shells can be produced from a meltable bath-model directly made from the steel mother-model.

Another aspect of the invention is to provide a method for manufacturing nickel shells wherein the bath-model is made by spraying or casting the master-model with a low-melting-point-alloy (or LMPA) onto the mother-model.

Still another aspect of the invention is to provide a method of producing a nickel shell wherein the bath-model can be easily released from the steel mother-model in such a way that both the bath-model form and copied surface are undamaged during the release process.

Yet another aspect of the invention is to provide a method to produce a nickel shell such that the bath-model is used as a cathode in the nickel electro-depositing bath, wherein a two-layer shell is formed, wherein the inner layer is a LMPA bath-model and the outer layer is a nickel shell.

Another aspect of the invention is to provide a method of producing nickel shells from a steel etched mother-model in a similar manner as injection-molding parts are molded from a steel etched mold.

Finally, it is aspect of the invention is to provide a method to produce a nickel shell where the melted inner bath-model layer is recycled to produce new bath-models and the nickel shell produces an accurate negative of a copied textured surface.

The invention is a method of model fabrication wherein a cast metal mold is coated with a LMPA that is then over-coated with a nickel alloy by electro-deposition to provide a nickel shell mold that may be released from the base-model by melting the LMPA.

### BRIEF DESCRIPTION OF THE DRAWINGS

FIG. 1 is a cross-sectional view of a typical mother-model made of steel in accordance with the invention.

FIG. 2 is an illustration showing the application of the LMPA over the steel mother-model.

### DETAILED DESCRIPTION OF THE INVENTION

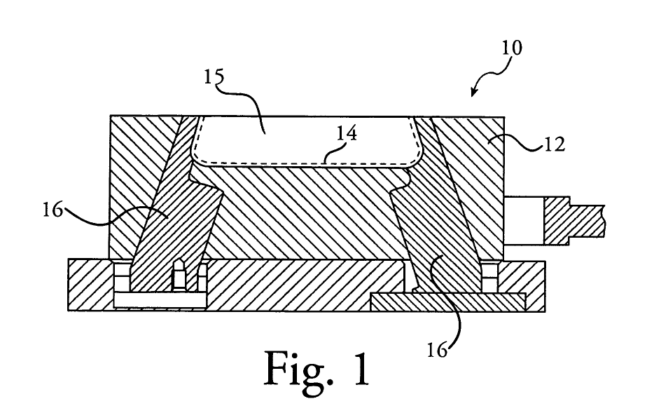

Referring now to FIG. 1, the first step in the inventive method 10 is the production of a steel “mother-model” 12 (note the inventive method eliminates the need of a master-model.) Mother-model 12 is chemically etched in surface 14 in the pattern that is to be copied on the elastomeric skin (not shown). Surface 14 is produced in a negative form so that the elastomeric skin is produced as a positive surface. In this way, the prior art “master-model” step is not required.

The inventive molding method enables the elimination of prior art molding steps such as manufacturing a leathered master-model; casting the master-model into a reference negative silicone cast; pouring resin in the referenced silicone cast to produce a solid positive reference resin mother-model and using the mother-model to produce several mother-model negative silicone casts.

The present method of directly providing a negative steel mother-model is equivalent to the several prior-art non-durable negative silicone casts that are used to produce the requisite positive electro-deposited bath-models for the negative nickel shell manufacturing.

Instead of the prior art use of a negative silicone cast, the etched surface 14 is dimensionally suitable and formed to produce a positively textured “bath-model” for the deposition of a negatively textured nickel shell.

Invention 10 further includes mechanical slides 16 which when opened allow easy de-molding of the “bath-model”. Slides 16 are mechanically machined, assembled and adhered to strict mechanical tolerances to allow correct “bath-model” de-molding operations. This also allows repeated positioning of the moving parts. In fact, the same mother-model 12 can be used to produce several bath models. As noted above, the molding process found in the prior art was run first using a leather master-model, and then run having a resin mother-model. Using the inventors' method, the model approval process by a customer first might be accomplished by use of a virtual rendering of the textured part that is eventually replicated and controlled in the negatively printed etched cavity 15. It can be then printed through modern seamless printing techniques and prior etching. The part can then be submitted to an intermediate approval process. Once cavity 15 is etched, the approval process is able to confirm the “mother-model” upon verification of the first positive “bath-model” produced from the etched steel mother-model 12. Whenever needed, retouches can be performed onto the mother-model cavity, similarly to etched molds, to achieve the requisite appearance. As mentioned above, because of the steel mother-model 12's durability and repeatability, there is no need to produce multiple silicone casts for bath-model sets since the bath-models are directly produced from the same steel mother-model 12.

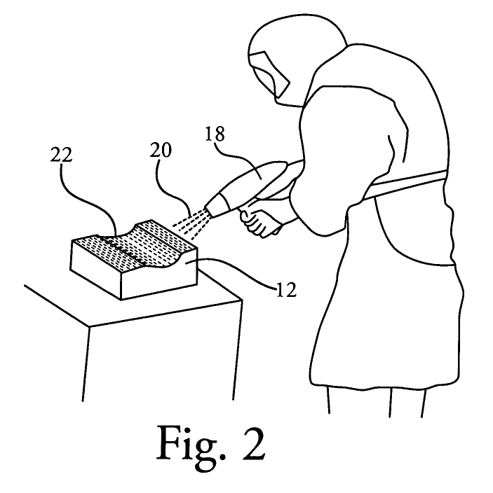

For positively textured bath-model production as shown in FIG. 2, the steel mother-model 12's etched surface 14 is thermo-sprayed 20 (can be arc-sprayed) with a LMPA via spray gun 18. Several LMPA materials that have different melting points ranging from 130° C. to 270° C. to provide suitable copying ability. The main component is Tin (ranging from 20% to 80%). Depending on the part that is to be molded (such as size, draft angles, geometrical form, and pattern's details), different percentages of tin used in the LMPA are optimized to provide process performance, according to specific requirements such as thermo-spray cycle time, melting point, part stiffness, grain fineness, etc.

As distinguished from the prior art, the produced “bath-model” is lighter because it is just a shell and it is not a solid model. Once the “bath-model” is cooled, it can be conveniently released from the opened steel mother-model's cavity 15 in such a way that both the bath-model form (not shown) and its copied surface are undamaged.

Again as distinguished from the prior art, the resin “bath-model” is non-electrically conductive. Therefore, to electrically deposit nickel, the resin bath-model must be coated by a silver layer. Using the invention, the inventor's “bath-model” is directly used as a cathode in the nickel electro-depositing bath. As a result of the depositing process, a two-layer shell, whose inner layer is the LMPA bath-model shell and the outer one is the electro-deposited nickel shell, is obtained.

By heating the two-layer shell, the LMPA layer is melted and the LMPA material is eventually recycled to produce new bath-model shells. The outer layer nickel shell has an inner side as the negative copied textured surface that then can be used to replicate a positively formed skin.

This novel method allows for the production of bath-model from steel etched mother-models in a similar manner as injection molding parts are molded from steel etched molds. The inventive method therefore produces skins that are in harmony with plastic molded parts.

Moreover, digital artworks developed for the production of desired patterns can be digitally and conveniently adapted (emphasized, rounded, softened, contrasted, veined, and so on) to replicate the intended appearance of any textured components. By combining suitable LMPA with artworks, top-performing appearance can be achieved. It is possible to produce results (details, gloss levels, gloss contrasts) among parts and skins from different technologies; materials and forms yet are in harmony with one another. This is due to the inventive method's flexibility to perform appearance harmonization of skins from nickel shells with parts from other texturing techniques: this method to achieve harmonized skins with textured parts from different texturing techniques is far superior than any prior art modeling process starting with physically leathered models that must be followed by a rigid and long production process.

While certain representative embodiments of the invention have been described herein for the purposes of illustration, it will be apparent to those skilled in the art that modification therein may be made without departure from the spirit and scope of the invention.

What is claimed is:

1. A method of model fabrication of a thermoplastic elastomeric skin with a predetermined pattern using a nickel shell comprising the steps of:
engraving a negative of the predetermined pattern on a steel model that is dimensionally stable;
thermo-spraying said steel mother model with a low melting point alloy (LMPA) to provide a bath model wherein said bath model is directly suitable as a cathode;
cooling said bath model so that said bath model can be released from said mother model without damaging neither said LMPA bath model nor the copied positive predetermined surface thereon;
electro-depositing a nickel shell onto said bath model wherein said deposited nickel shell provides a negative of said predetermined surface;
heating the two-layer bath model with its deposited nickel shell such that said LMPA is melted leaving only the nickel shell with the negative of said predetermined surface;
placing said thermoplastic elastomeric skin onto said nickel shell to provide an accurate positive copy of the predetermined surface on said skin.

2. The method of claim 1 further comprising the step of:
de-molding said bath model using mechanical slides associated with said mother model to allow repeated repositioning of mold parts in order to permit multiple nickel shells from the same mother model.

3. The method of claim 1 wherein said LMPA has a melting point ranging from 130° C. to 270° C.

4. The method of claim 1 wherein said LMPA is primarily tin ranging from 20% to 80% of the alloy.
